(19) United States
(12) Patent Application Publication
(10) Pub. No.: US 2026/0118840 A1
(43) Pub. Date: Apr. 30, 2026

(54) MULTI SENSOR ARRAY SMART PLUG

(71) Applicant: Wellnuo LLC, Saratoga, CA (US)

(72) Inventors: Robert ZMRZLI, Saratoga, CA (US); Bernhard KNIGGE, Saratoga, CA (US)

(21) Appl. No.: 19/433,370

(22) Filed: Dec. 26, 2025

Related U.S. Application Data
(63) Continuation-in-part of application No. PCT/US2024/034838, filed on Jun. 20, 2024.
(60) Provisional application No. 63/512,289, filed on Jul. 7, 2023.

(51) Int. Cl. G05B 13/02

(52) U.S. Cl. CPC G05B 13/028

(57) ABSTRACT

A smart home monitoring device is configured to plug into an electrical outlet and includes a multi-sensor array, excluding audio and video sensors, for monitoring environmental conditions, behavioral patterns, and odor-related indicators within a monitored environment. The device includes Bluetooth Low Energy communication with angle-of-arrival capability to enable sub-meter asset tracking, and supports home automation control through programmable automation frameworks such as IFTTT or Node-RED to initiate safety responses. The system further provides multi-tiered burglar detection through correlated event analysis across multiple sensor inputs, and generates health-related risk indicators based on detected patterns. Visual indicators, including multi-color LED illumination and blinking patterns, are used to communicate alert types and severity levels. The system enables non-intrusive monitoring while supporting proactive safety, security, and health management.

### CROSS-REFERENCE TO RELATED APPLICATIONS

This application is a continuation in part (CIP) application to PCT/US2024/034838 filed June 20, 2024 which claims priority under 35 USC 119(e) to U.S. Provisional Patent Application Ser. No. 63/512,289, filed July 7, 2023, all of which is incorporated herein by reference in their entirety.

### BACKGROUND OF THE INVENTION

### 1. Field of the Invention

The present invention relates to smart devices and more particularly to a multi sensor array smart plug.

### 2. Description of Related Art

Unless otherwise indicated herein, the approaches described in this section are not prior art to the claims in this application and are not admitted to be prior art by inclusion in this section.

A large percentage of the elderly population prefer to live at home alone for the peace of mind that it provides them and for the convenience and benefits that the elderly person feels comfortable and safe in. However, family members and loved ones may be concerned about the safety and wellbeing of the elderly person if they are living alone, because of the possible cognitive decline or safety risks. Thus, there is a need for a home monitoring solution to monitor every room and his or her surroundings in the home environment without intruding on their privacy.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In one aspect of the invention, a home monitoring device is provided, comprising a housing having electrical prongs adapted to plug into an electrical outlet; a sensor array within the housing including at least one of: temperature, VOC/VSC, radar presence, CO2, and light sensors, wherein the sensor array excludes audio and video sensors; a Bluetooth Low Energy (BLE) interface configured to detect BLE beacon tags and implement Angle-of-Arrival (AoA) positioning; a wireless interface configured to communicate with a data server and smart home devices; an LED status indicator with variable color and blinking frequency; a processor configured to: receive sensor data, detect asset movement via BLE signals, execute stored automation rules, and control the LED status indicator based on detected events.

In one embodiment, a second electrical outlet is provided and configured to provide power to a secondary electronic device and monitor its power consumption. In one embodiment, the BLE interface achieves sub-meter location accuracy for BLE beacon tags using antenna array phase difference measurements. In one embodiment, the LED indicator displays different alert types through combinations of color and blinking patterns including: steady for low urgency, slow pulse for awareness, medium blink for moderate urgency, rapid flash for high urgency, and strobe for emergency. In one embodiment, an onboard memory storing baseline sensor patterns, the stored automation rules, and BLE beacon registry data.

In another aspect of the invention, a method for asset tracking in a home environment is provided, comprising steps attaching BLE beacon tags to valuable assets; detecting BLE signals from the beacon tags using a home monitoring device with AoA capability; establishing baseline location data for each beacon tag; monitoring signal strength and calculated position of each beacon tag; generating a theft alert when a beacon tag moves beyond a threshold distance or the BLE signal is lost for a predetermined time.

In one embodiment, the AoA capability determines beacon location by measuring phase differences between signals received at multiple antennas and calculating angular direction. In one embodiment, a further step of distinguishing authorized movement from unauthorized movement by detecting presence of authorized user devices via Bluetooth or WiFi is provided. In one embodiment, a further step of generating graduated alert severity levels based on asset value tier, distance moved, and time of occurrence is provided. In one embodiment, a further step of providing asset recovery information including last known location, trajectory history, and historical access logs is provided. In one embodiment, a further step of transmitting the theft alert to a caregiver device and activating a distinctive LED pattern on the monitoring device is provided.

In another aspect of the invention, a smart home control method is provided, comprising steps of monitoring environmental conditions including gas concentration, VOC, water presence, humidity, and temperature using a sensor array; executing conditional logic rules based on sensor thresholds using IFTTT or Node-RED protocols; transmitting control signals to smart home actuators via wireless protocols when thresholds are exceeded; wherein the conditional logic rules include: shutting off gas valve when gas detected, shutting off water main when leak detected, activating ventilation when CO2 exceeds threshold, and triggering fire alarm when smoke signature detected. In one embodiment, the conditional logic rules are user-configurable through a mobile application, web portal, or voice command interface. In another embodiment, a further step of implementing Node-RED visual programming with sensor input nodes, function nodes for conditional logic, and actuator output nodes is provided. In another embodiment, a further step of executing multi-step automation sequences is provided including chained actions with time delays, parallel execution of multiple responses, and feedback loops incorporating sensor verification. In another embodiment, a further step of integrating with external services including weather forecasts, utility pricing APIs, and calendar services to optimize automation timing. In another embodiment, a further step of storing automation flows locally with cloud backup for redundancy is provided.

In yet another aspect of the invention, an intelligent burglar detection method is provided, comprising steps monitoring for intrusion indicator events including at least one of: door openings, window openings, light activations, and motion in unoccupied zones using distributed home monitoring devices; timestamping and geo-tagging each detected event; analyzing an event sequences of the detected event occurring within a configurable time window; calculating an intrusion probability score based on satisfaction of multiple contextual conditions of the detected event; and implementing a graduated alert response based on the intrusion probability score.

In one embodiment, the multiple contextual conditions include: entry detection, interior illumination activation, movement in living room, movement in office, event occurrence during 2 am-6 am, and absence of motion in bedroom. In one embodiment, the graduated alert response includes: logging event for low probability, sending push notification for medium probability, and sending SMS with voice call and activating loud alarm for high probability. In another embodiment, further comprising a step of distinguishing suspicious patterns from normal activity by comparing against learned baseline behavior and considering current home mode. In another embodiment, further comprising a step of rapid disarming of the graduated alert response through a mobile app authentication, a voice passphrase, a proximity detection of authorized devices, or a security code entry. In another embodiment, further comprising a step of learning from false alarms by adjusting threshold parameters based on user feedback and creating exception rules. In another embodiment, further comprising a step of replicating alert status on a designated caregiver's remote monitoring device including LED pattern, zone identification, timestamp, and severity level.

In another aspect of the invention, a health risk assessment method is provided comprising steps monitoring behavioral patterns including sleep duration and quality, bathroom visit frequency, movement patterns, and daily activity routines; generating smell fingerprints through VOC/VSC sensing including endogenous biomarkers, dietary patterns, and temporal changes; receiving external health metrics including heart rate, blood pressure, blood glucose, and body weight; correlating multiple factors using machine learning to generate disease-specific risk scores.

In one embodiment, the step of generating disease-specific risk scores comprises analyzing sleep patterns in conjunction with evening consumption detected via VOC, room temperature and humidity, heart rate patterns, movement during sleep, and bathroom visit frequency. In one embodiment, the disease-specific risk scores include cardiovascular disease risk based on blood pressure patterns, sleep quality, activity levels, dietary habits detected via VOC, and stress indicators from heart rate variability. In one embodiment, the disease-specific risk scores include diabetes risk based on glucose measurements, detected food consumption patterns, acetone levels, sleep disruptions, activity levels, and weight trends. In one embodiment, the disease-specific risk scores include cognitive decline risk based on behavioral pattern changes, sleep quality degradation, bathroom visit pattern changes, movement precision variations, and social interaction frequency. In one embodiment, the disease-specific risk scores include depression and anxiety risk based on activity level changes, sleep pattern disruptions, social interaction frequency, movement patterns, and stress indicators from heart rate variability. In one embodiment, the step of generating smell fingerprints comprises detecting acetone levels for ketosis, volatile fatty acids for metabolic conditions, ammonia for kidney function, and sulfur compounds for digestive health. In another embodiment, the step of generating smell fingerprints comprises detecting coffee consumption, alcohol consumption, fried food cooking, meal timing, and medication odors. In one embodiment, a further step of generating predictive assessments is provided including short-term health event probability, medium-term health trajectory projections, and long-term chronic disease risk. In one embodiment, a further step of triggering graduated alerts for acute health events requiring immediate attention, concerning trends warranting healthcare consultation, and positive improvements. In one embodiment, a further step of generating clinical-grade reports for healthcare providers through HIPAA-compliant encrypted transmission and integrating with electronic health record systems.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 illustrates an exemplary smart device according to some embodiments.

FIG. 2 illustrates the sensor array within the smart device.

FIG. 3 illustrates a system diagram according to some embodiments.

FIG. 4 illustrates a flow diagram depicting utilization of a trained machine learning model for evaluating sensor data according to some embodiments.

FIG. 5 illustrates a flow diagram depicting utilization of a trained machine learning model to generate health-related assessments according to some embodiments.

FIG. 6 illustrates how sensor data is processed according to some embodiments.

FIG. 7 illustrates the classification of events that a deep neural network (DNN) can accomplish according to some embodiments.

FIGS. 8a, 8b, 8c, and 8d illustrate different views of an exemplary smart device according to some embodiments.

FIG. 9 depicts a simplified block diagram of an example computer system 900, which can be used to implement some of the techniques described in the foregoing disclosure.

FIG. 10A illustrates an overview of an asset tracking module in which BLE beacon tags attached to household items are detected by the smart device according to some embodiments.

FIG. 10B illustrates an example of the asset tracking module in use when a beacon tag is moved, lost, or stolen according to some embodiments.

FIG. 11 illustrates an exemplary circuit diagram for the asset tracking module according to some embodiments.

FIG. 12 illustrates an angle-of-arrival computation derived from the asset tracking module according to some embodiments.

FIG. 13 illustrates an example home automation control system in which a smart device is integrated with an automation environment to monitor environmental conditions and control smart home actuators according to some embodiments.

FIG. 14 illustrates an example multitiered event correlation and alert logic for intelligent burglar detection according to some embodiments.

### DETAILED DESCRIPTION OF THE PREFERRED EMBODIMENT

Described herein are methods and apparatuses to non-intrusively monitor one or more persons or animals in a home environment. While the description below will focus on the usage model of one person living alone in the home, it is to be understood by those skilled in the art that the solution can also apply to scenarios where multiple people are living in the home. A smart sensor array plug device (“smart device”) is described which can be used as both a human monitoring device and also as a home environment monitoring device. The smart device can include 5 to 10 different sensors. The sensor array includes as a minimum of the following 5 sensors: 1) Temperature, 2) smell (volatile organic compounds—VOC, Volatile sulfur compounds—VSC), 3) Presence Radar, 4) CO2 gas and 5) light sensor. The preferred embodiment includes the additional 2 sensors: 6) Humidity and 7) pressure (Barometer). Additional sensors yield small incremental benefit but could include 8) (passive) infrared or thermopile, 9) CO gas 10) particle counter (i.e. PM2.5). The sensor array may capture data related to the ambient environment surrounding the smart device. In other embodiments, the smart device may be used in other applications to monitor the ambient environment. For example, the smart device may be used by plant growers to monitor the environment of the greenhouse. Output from the smart device can be used to optimally control the greenhouse environment to create an optimal environment to grow plants. The alerts generated by the smart device that indicate the greenhouse environment is not optimal may be transmitted to a botanist or farmer who in turn may manually or automatically correct the environmentals in a home environment. While the description below will focus on the usage of one person living alone in the home, it is to be understood by those skilled in the art that the solution can also apply to scenarios where multiple residents live in a home.

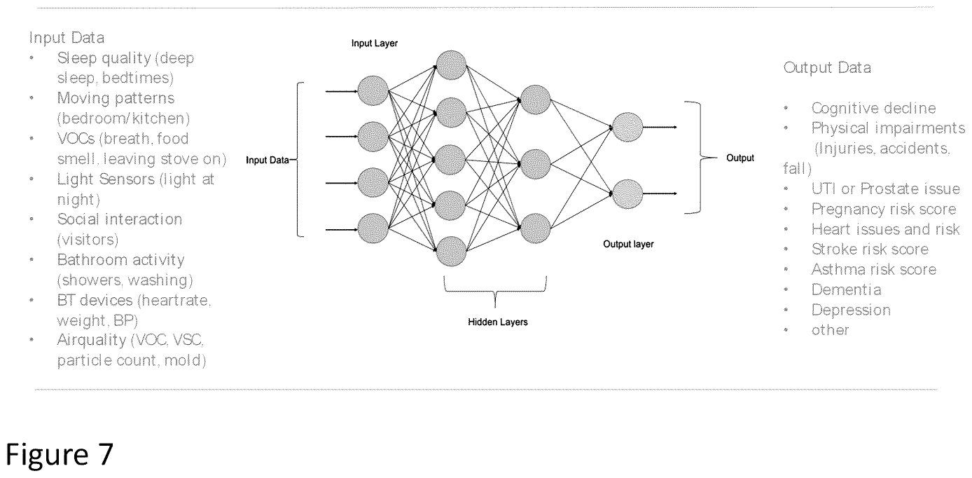

The sensor array is connected to a CPU to allow data acquisition and to WIFI and/or Thread connection to wirelessly send sensor data to cloud-based storage system/and or local memory chip. In one embodiment, the smart device with the sensor array may store the various sensor traces in the local memory chip and apply a machine learning model or sensor fusion algorithms to create use cases and indicate deviations from normal that would then alert the user and family members or caregivers. Alternatively, data analysis can occur in a data center or data server in the cloud. In yet other embodiments, a first portion of the data analysis may happen on the smart device while a second portion of the data analysis may happen external to the smart device. This is shown in FIG. 7 where certain input data for the deep neural network running external to the smart device such as sleep quality and moving patterns may be generated by the smart device from analyzing sensor data (sensor data may be generated from the smart device or generated from another smart device in the home) while other input data such as light sensors may be generated by sensors on the smart device and transmitted to deep neural network to be used as input data. The smart device has a series of LED light indicators to show the status of various events and it could also serve as a night light. Each room in the house could have a plug with an integrated sensor array to track door openings and movements.

The sensor array is connected to a CPU to allow data acquisition and to WIFI and/or Thread connection to wirelessly send sensor data to cloud-based storage system/and or local memory chip. In some embodiments, sensor data is transmitted wirelessly using one or more communication protocols including, but not limited to, Wi-Fi, Thread, Zigbee, LoRa, or other suitable wireless networking technologies. In some embodiments, a low-level peer-to-peer communication protocol is implemented to support efficient local device-to-device communication, including mesh or multi-hop networking. In one embodiment, the smart device with the sensor array may store the various sensor traces in the local memory chip and apply a machine learning model or sensor fusion algorithms to create use cases and indicate deviations from normal that would then alert the user and family members or caregivers. Alternatively, data analysis can occur in a data center or data server in the cloud. In yet other embodiments, a first portion of the data analysis may happen on the smart device while a second portion of the data analysis may happen external to the smart device. This is shown in FIG. 7 where certain input data for the deep neural network running external to the smart device such as sleep quality and moving patterns may be generated by the smart device from analyzing sensor data (sensor data may be generated from the smart device or generated from another smart device in the home) while other input data such as light sensors may be generated by sensors on the smart device and transmitted to deep neural network to be used as input data. The smart device has a series of LED light indicators to show the status of various events and it could also serve as a night light. Each room in the house could have a plug with an integrated sensor array to track door openings and movements.

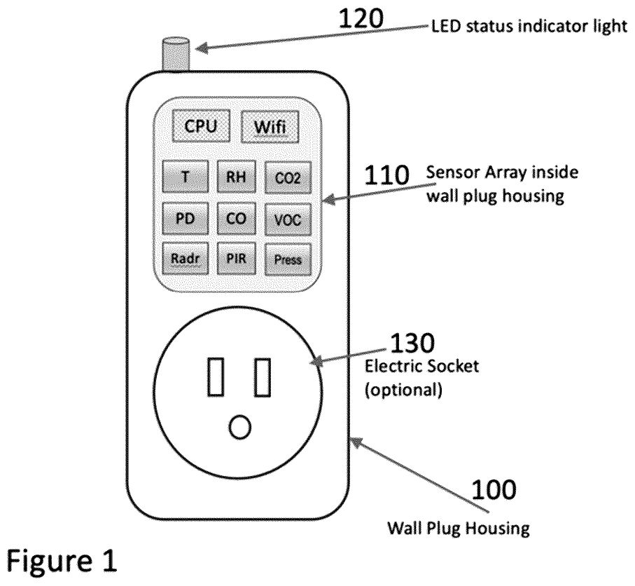

FIG. 1 illustrates an exemplary schematic of a smart device according to some embodiments. As shown, the smart includes housing 100, sensor array 110, LED status indicator light 120, and electric socket 130. The smart device may contain a set of electrical prongs configured to removably connect to a wall outlet or a socket of an extension cord to receive power so therefore the smart device does not operate off of battery power. This is advantageous since elderly people may sometimes forget when it's time to replace batteries in devices so plugging the smart device into a socket guarantees constant power to the smart device. In some embodiments, the smart device can also be used as a ‘smart plug’-meaning that a secondary electronic device may be plugged into the smart device via electric socket 130 to be either turned on/off or dimmed if plugged device is light. In one embodiment, the smart device may also measure the power consumption of the secondary device through electric socket 130. While the smart device shown in FIG. 1 includes electric socket 130, it is to be understood that the smart device can function without the electric socket, so the electric socket is optional.

LED light 120 of the smart device can be configured to alert the monitored subject, caregiver, or others in the home environment on the air quality or unusual behavior happening near the smart device. Alternatively, LED light 120 can also be configured to alert the monitored subject, caregiver, or others in the home environment that there is a risk score associated with the monitored subject that has been generated and is ready for review. The risk score may be accessed by the monitored subject, caregiver, or other through a website or an application running on a mobile phone, tablet, computer, or other computing device. For example, LED light 120 may be utilized to alert poor air quality. As another example, LED light 120 may be utilized to alert that the stove nearby has been left on, that a nearby window or door has been left open, or that a fall or slip has been detected. The color of this status light can be of any desired color, but the preferred embodiment is green/yellow/red on/off white light as a night light. In some embodiments, alerts represented by the LED light 120 can also be relayed to an application running on a smart phone or smart watch of the monitored subject or persons monitoring the subject. Advantages of these alerts are that they may provide peace of mind to the monitored subject, caregiver, and persons monitoring the subject. For example, a green light status may mean that the smart device has determined that the sensor data collected by the smart device have not detected anything to be concerned about, thus giving the monitored subject or caregiver with visibility to the smart device peace of mind.

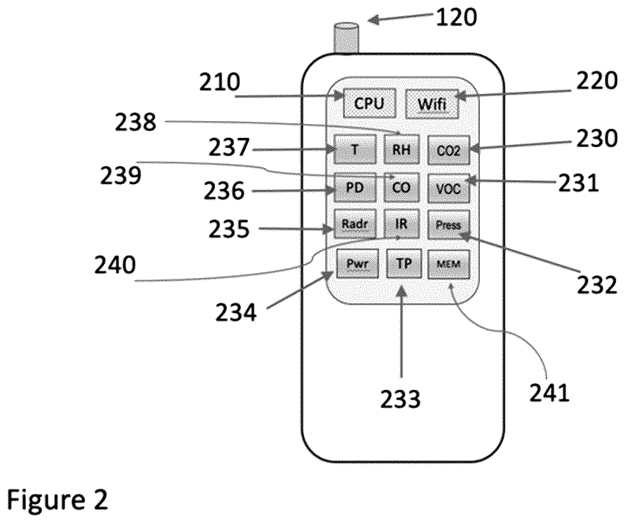

FIG. 2 illustrates the sensor array within the smart device according to some embodiments. As shown, the smart device includes CPU 210 and a Wi-Fi/Thread connection 220 which is configured to provide wireless and internet connectivity. In some embodiments, the WIFI/Thread can be a BLE connection. The wireless connectivity may serve to provide sensor data traces captured by the smart device to a local data server or a remote cloud-based storage data center. The Bluetooth (BLE) connectivity allows other health tracker devices to connect to the smart device (i.e. heart rate monitor, blood pressure meters, glucose meter, panic buttons, digital scales, audio or video devices), thus increasing the amount of sensor data available for analysis by the smart device. Today most of these BLE devices connect only to your cell phone and requires various apps to be installed and running. This is tedious and requires the proximity of the phone and that the phone is charged.

The smart device can include several environmental sensors to detect the ambient environment near the smart device. As shown here, the smart device in FIG. 2 includes temperature sensor 237, humidity sensor 238, carbon dioxide CO2 gas sensor 230, smell-volatile organic compounds VOC/VSC 231, barometric pressure sensor 232, thermopile sensor 233, power meter sensor 234, radar presence sensor 235, light sensor photodiode 236, carbon monoxide (CO) sensor 239, infrared IR sensor 240. While all of these sensors are shown here, it is to be understood that not all of these sensors are required in the smart device. In one embodiment, a subset of these sensors that include Radar presence, temperature, humidity, light sensor, CO2, VOC/VSC combo sensor, barometer may be preferred. The VOC sensor may be a variety of VOC sensors, depending on implementation details. In one example, the VOC is a mVOC capable of detecting mold. In another embodiment, the following additional sensors can be added to the 8 sensors above to enhance the sensor robustness of the device: carbon monoxide CO sensor, (passive) infrared, a thermopile, particle counter. The selection of which sensors to include in a particular application may depend on conditions of the home environment that is being monitored.

Certainly, having a passive infrared motion (PIR) 240 sensor is cheaper than a radar presence or motion detector 235 but requires the unit to be in the field of view of any events and cannot be obstructed by furniture. PIR also have a reduced sensitivity, field of view and cannot be used to gauge distance. Therefore, if the smart device is likely to be obstructed by furniture in the home environment, then a radar presence of motion detector 235 may be preferred over a passive infrared motion sensor 240. Thermopiles (TP) 233 can be used to gauge if multiple people are in the room and can be somewhat directional. Therefore, a TP sensor may be preferred if the smart sensor can be pointed towards a stove for example, since 80% of all home fires originate from the stove.

In another embodiment the smart device also has an onboard memory chip 241 to store several days of data in case of network outage or for data analytics performed on the smart device.

In one embodiment, multiple smart devices may be installed in the home environment and the smart devices may communicate with one another, for example through Wi-Fi, Bluetooth, Thread, Zigbee or LORA mesh. This may be advantageous since multiple smart devices may allow for advanced differential detection capability. For example if a person opens a door, a first barometric pressure sensor on a first smart device plugged into a first room might measure a pressure drop and a second barometric pressure sensor on a second smart device plugged into a neighboring room measures a pressure increase thereby enhancing the detection capability for door or window openings. Furthermore, one can average detected sensor values over multiple rooms (i.e. to detect AC/Heater going on/off or weather patterns).

Since each smart plug has a CPU processing unit it can also do some data analysis and machine learning on the device itself. This is useful for event classification and to accelerate an alarm/notification to be sent to the caregiver and user. Since each device is connected to each other through Wi-Fi/mesh and/or Bluetooth it leads to an enhanced computing power and improved event classification and a more robust Al smart device.

All sensor data, including attached bluetooth device data from health trackers are encrypted and sent to the cloud/enterprise server—where it is stored for long term data analysis. Long term trends that are happening over extended periods of time such as weeks or months can be analyzed and could be used to look at correlation and causation of events. In one embodiment, the smart device utilizes its sensors to detect smells in the home environment. For example, the smart sensor may detect the smell of coffee or fried food and compare that data with the sleep pattern or bathroom activity of the monitored subject the following night. Similarly, CO2 levels or VOC levels may impact sleep or bathroom activity and are logged over years and may indicate behavior changes that could be measured by a recurrent neural network timeseries analysis.

In one embodiment, the smart device may generate a smell fingerprint for the household, or for each room, or for the ambient environment surrounding the smart device from sensor data received from the VOC sensor. The smell fingerprint can be updated over time and can be based on sensor data collected by the smart device. For example, the smart device may incorporate a VOC sensor that is configured to collect sensor data to detect certain odors and smells. For example, a VOC sensor may be able to detect acidoketosis which is a biomarker for diabetes and or keto diet. VOC can also detect presence of alcohol, gas and/or mold. In one embodiment, the smell fingerprint may detect and differentiate odors in the static ambient environment (e.g., carpets, walls, furniture, paintings, etc.), also known as a reference room smell and odors of the monitored subject, also known as monitored subject smell. The ability of the smart device to generate a smell fingerprint of the monitored subject in the environment may depend on whether the room/environment is vented or unvented. Unvented rooms and environments may collect the odor of the monitored subject over time, thus making it easier to generate a smell fingerprint on the monitored subject. The smart device may be able to detect whether the room is vented or unvented. In other embodiments, the vented/unvented setting may be set by the user of the smart device.

In one embodiment, the smart device may be configured to generate a reference room smell of the ambient environment or room when the monitored subject is not present and use that reference room smell as a baseline to compare against when the monitored subject is present in the room. The reference room smell, also known as exogenous smell, can be due to odors from the furniture in the environment, the carpets in the environment, the paint in the environment, just to name a few. It may be advantageous to generate a reference room smell to be used as a baseline by smart device because any smells other than the reference room smell can be attributable to changes in the ambient environment. For example, the changes in the ambient environment may be due to a smell signature that is associated with environmental changes, such as the stove has been left on, there is smoke in the room, there is mold, or the humidity is too high. As another example, the changes in the ambient environment may be due to odors coming from the monitored subject in the room. The smart device may be configured to analyze the odors coming from the monitored subject and generate a monitored subject smell. The VOC sensor can also differentiate and include smell signatures of deodorants, perfumes, soaps, hair gel, beauty products, shower gel, shampoo and conditioner. However, the monitored subject smell may include bio markers for certain diseases such as flu, pneumonia, lung cancer, stroke, or diabetes. The monitored subject smell that includes these bio markers may be combined with other inferences generated from sensor data such as sleeping or moving habits of the monitored subject to generate a risk score for each of these diseases. The risk score can be generated by the smart device or alternatively external to the smart device such as at a data center or other cloud system.

Commercially available VOC sensors are capable of measuring parts per billion (ppb) of various VOCs. The sensor may receive a gas mixture, preheat the gas mixture, and detect the result of the preheating. The sensor may be able to detect thousands of different odors and smells based on the gas mixture in the air and the exposure time to the sensor. For example, detecting a coffee smell may include preheating the gas mixture for a certain time. In another example, detecting a dirty diaper may include preheating the gas mixture for a different time. As another example, the smart device may be able to detect that a diabetic person is in the ambient environment of the smart device based on the smell fingerprint. In yet other embodiments, the smell fingerprint may be generated external from the smart device. For example, the smell fingerprint can also be generated at a data center or elsewhere in the cloud, on a system executing a machine learning model. Depending on the complexity of the smell fingerprint, generating the smell fingerprint externally may be beneficial if additional compute power is required.

In one embodiment, the smart device may include a mold mVOC sensor. A mVOC sensor is capable of detecting microbial volatile organic compounds (mVOC) that are released during the metabolic processes of decay agents such as fungi, bacteria, and biofilm. The off gassing of mVOCs include a wide range of gasses including ethanol, alcohols, methane gas, ketones, aldehydes, esters, carboxylic acids, lactones, terpenes, aromatic hydrocarbons, sulfurs, and nitrogen compounds. mVOCs produced during primary fungal metabolism include ethanol, l-octen-3-ol, 2-octen-l-ol, and benzyl cyanide. mVOCs produced during secondary metabolism include 2-methyl-isobomeol, geosmin (1-10-dimethyl-trans-9-decalol) and terpenes. These mVOCs may be detectable by a mVOC sensor and used as sensor data in the smart device.

In one embodiment, a user may specify to the smart device the smell signatures to focus on. If there are predefined smell signatures, the smart device may prioritize detecting the predefined smell signatures. In other embodiments where there are no predefined smell signatures, the smart device may vary the preheat time and attempt to detect a wide range of smells. The smart device may take the results of the smell signature and generate inferences such as whether the air is healthy is outside EPA guidelines, whether someone in the room is drinking coffee, whether someone in the room is eating fried foods, whether someone in the room is drinking alcohol, or whether someone is in the room is smoking. In some embodiments may be able to detect diseases and health conditions, such as cancer, COVID, stroke, and diabetes. For normal healthy humans normal endogenous volatile metabolites produces the following ubiquitous VOCs in the breath: isoprene (12-580 ppb), acetone (1.2-1880 ppb), acetaldehyde (3-7 ppb), ethyl acetate (ND-116 ppb), butanone (6-26 ppb), 1-butene (ND-495 ppb), dimethyl sulfide (ND-46.5 ppb), ethylene (ND-233 ppb), furan (ND-78.4), hexanal (9-13 ppb) and many more. Exogenous VOC from the surrounding air are mixed in and the machine learning algorithm will determine (based on sleep and room activity) the quality and usability of the smell fingerprint to detect disease.

In some embodiments, a neural network may analyze the vector array signatures generated by the sensors of the smart device to correlate the sensor data to inferences made from the sensor data. The neural network model may be a Recurrent Neural Network, Deep Neural Network, Convolutional Neural Network, or other neural network model. In one example, the dataset used to train the neural network may come from all households that have the smart device installed. In another example, a subset of all the household data sets can be used, wherein the subset is based on region/country/locality or the characteristics of the monitored subjects such as age, gender, health status, or pre-existing conditions. Using a subset specific to the monitored subject may result in a model that is customized for the monitored subject.

In some embodiments, weather information and global positioning system information can also be inputs to the neural network. The weather information and global positioning information may be useful to group entries in the training dataset so that monitored persons in similar weather conditions are grouped together for training or monitored subjects near one another are grouped together.

In another embodiment, the temperature in the bedroom as measured by the smart device and the relative humidity in the bedroom as measured by the smart device may be correlated with the quality of sleep of the subject. For example, a temperature above 80 degrees Fahrenheit and a relative humidity above 50% may be correlated with poor sleep in the monitored subject. In another embodiment, the relative humidity tracked over time may be able to detect mold. For example, a relative humidity of over 70% for a period of 7 days may result in a conclusion by the smart device that there is mold in the ambient environment of the smart device which can be corroborated by an mVOC sensor.

There are several use cases for each sensor and combination thereof. The smart device may analyze the sensors independently or in combination and generate predictions, also known as inferences. Each use case can be developed and learned over time in any given environment using a neural network type machine learning model. Alternatively, nearest neighbor (NN) and clustering algorithms are also useful to categorize events. Certainly, simple threshold algorithms can also be applied. For example, if sensors detect that the home temperature is below lO deg C and or above 30 deg C, the smart device can generate an alert which can be transmitted to recipients such as the monitored subject, caregiver, or monitoring party or visually shared through the LED status indicator light. As another example, if sensors detect that the relative humidity in the house exceeds a predefined percentage for a prolonged period of time, the humidity may create an environment that is prone to the development of mold/fungus. For example, a relative humidity above 70% for a period of 7 days may trigger a risk score of mold in the home. As a result, the smart device may generate an alert which can be transmitted to recipients or visually shared through the LED status indicator light.

A combinatorial use case example would be if sensors belonging to a smart device plugged into a room detect that CO2 and VOC levels are too high, the smart device could alert the user and caregiver to ventilate the room. Sensors detecting rising CO2 levels could also indicate additional people in the room. A yellow alert can be sent out if CO2 levels exceed 700 ppm and a red alert can be sent out if CO2 levels exceed lOOOppm.

These thresholds are EPA guidelines but can be adjusted by the user and tailored to the environment. Sensors detecting rising VOC levels could indicate that the fridge was opened or that the stove is on. Or it could indicate spoiled food. It may also indicate pet related odors in certain areas of the house. It may also indicate that the baby diaper is dirty.

Pressure sensors can be used to estimate door openings, ventilation and A/C units turning on and off. Higher accuracy can be achieved in a differential configuration with various rooms as described above. Pressure sensors can also be used for weather forecasting. In combination with radar presence, temperature, humidity, and light gauges, the smart device can predict whether somebody is entering or leaving a room or opening a window.

As another example, if a smart device is plugged into a bathroom and sensors within the smart device detect high humidity and higher temperature and motion/presence at a certain distance, analysis of the sensor data can predict that the shower is being used. The VOC sensor can also identify if shampoo/shower gel is being used to further enhance event classification. To detect a fall in the shower, the deviation of normal shower time can be taken into account (i.e. typically 1 Imin) then if no motion is detected for prolonged time (i.e. after 20 min both inside bathroom and outside bathroom) the analysis can predict that the monitored subject may have slipped and fallen in the bathroom. An alert may be sent to the caregiver/family members in response. In some embodiments, the smart device may go through a decision tree model before sending an alert. For example, if a sensor detects that the monitored person is in the bathroom, the smart device may transition to an event of checking the CO2 levels, light, smell, and humidity. The smart device may then decide whether to generate an alert based on the inferences from this group of sensor data.

In another embodiment, the smart device may gauge and track habits and report deviations from normal behaviors. For example, let's assume it usually takes a monitored subject (e.g., elderly person) 3 minutes to get dressed and 30 seconds to walk to the bathroom. As part of aging we observe mental and/or physical decline and if the time it takes to get dressed and walk to the bathroom becomes longer than expected given the subject's age and health, the smart device may generate an alert to the monitored subject and caregiver to schedule a visit with a doctor. It could also indicate injury.

In another embodiment, the smart device may generate alerts for intrusion and/or fire. This could particularly be useful in a vacation home or trailer as well as your primary residence. As described above, the pressure from door and window openings can be measured and the LED light on the device can turn red if the smart device determines that the detected sensor's data relates to a behavior that is considered ‘not normal.’ For instance, if sensors in the smart device detect certain doors open and motion detected in other areas of the house than the bedroom at 3 am at night, then the smart device may determine or predict that an intrusion is taking place. The smart device can in turn generate an alert to the monitored subject, caregiver, or persons monitoring the subject that an intrusion may be taking place.

In another embodiment, the smart device can be used to track sleep quality. Through the use of sensors on the smart device, the smart device can track how often the monitored subject is getting up at night to use the bathroom. The smart device can also distinguish different sleep phases. For example, the radar presence interface can gauge activity at various distances, which can in turn be analyzed by the smart device to determine whether the monitored subject is tossing and turning in bed or is in a quiet deep sleep phase. Sound sleep is an important indicator of overall wellbeing—and it is related also to mental decline and has shown to correlate with Alzheimer's. Hence tracking deep sleep times over year may be useful to predict mental decline.

In another embodiment, the smart device can be used to track infant sleep habits and to monitor breathing and motion issues. Similar techniques described above can be applied to detect infant breathing and motion. Sudden infant death syndrome (SIDS) may be preventable if the caregiver is alerted in a timely fashion.

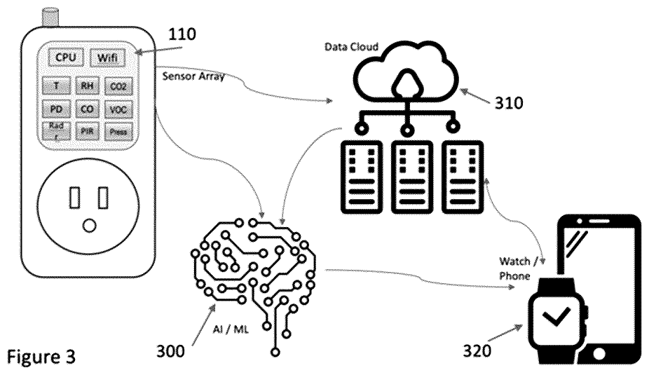

FIG. 3 illustrates a system diagram according to some embodiments. As shown, smart device 110 is in communication with the data server 310 and Al/machine learning model 300. Phone/tablet or laptop (“PTL”) 320 can communicate with the data server 310 and check raw sensor traces stored in the cloud. PTL can also communicate with the machine learning model 300 to track habits and set up notifications. For example, if the monitored subject goes to bed at 10 pm every night and gets up at 7 am, the machine learning model 300 can generate a habit for the monitored subject. If that habit is changing over time (i.e. we get up later and later) it may indicate some mental or physical problems and the smart device can generate alerts that are sent out to the monitored subject, caregivers, or persons monitoring the subject (e.g., family members). Advantages of such a system as shown in FIG. 3 include the ability to generate both short term predictions and long-term predictions. The short-term predictions may be generated by the smart device with sensor data measured by the smart device. Long term predictions may be generated by the AI/ML model 300 or data server 310 which can analyze the sensor data over a longer period of time. Longer predictions may include the sleeping habits or deviations of behavior of the monitored subject while short term predictions may include whether the CO2 or VOC levels are too high.

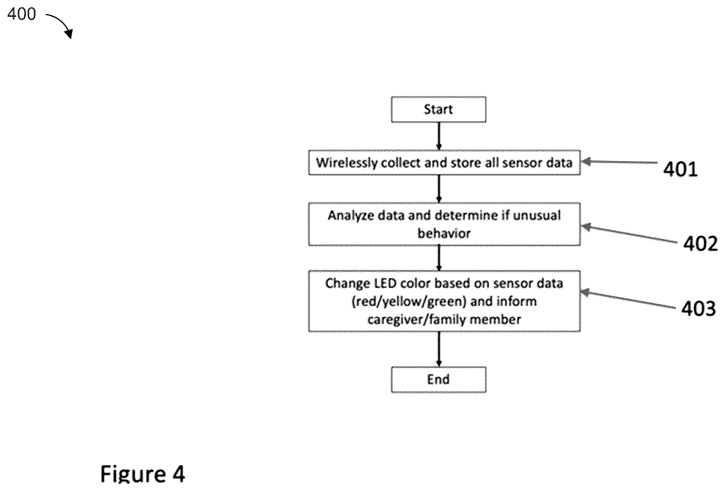

FIG. 4 illustrates a flow diagram depicting utilization of a trained machine learning model for evaluating sensor data according to some embodiments. Workflow 400 can be programmed in software code and stored in a computer readable medium to be read and executed using a machine learning model residing on a data server. Alternatively, workflow 400 can also be programmed in software code and stored in a computer readable medium to be read and executed by the smart device. Workflow 400 begins by wirelessly collecting and storing sensor data collected from one or more smart devices in the home environment at 401. Workflow 400 then continues by analyzing the data to determine if there are any unusual behaviors at step 402. In one embodiment, the machine learning model may establish baseline norms and compare currently collected sensor data with prior events. If there is unusual behavior, workflow 400 continues by informing the caregiver or family member at step 403. The alert can be in the form of changing the LED status indicator light on one or more smart devices in the home or transmitting a notification to a device belonging to the caregiver or family member. The machine learning model can be unsupervised or supervised learning. In an unsupervised model, all the data is automatically fed into the computer and ‘normal’ baseline data is created after a few months of monitoring. In a supervised learning model, certain thresholds are already pre-programmed. For example, if temperature and humidity or CO2 levels are out of normal range an alert is sent.

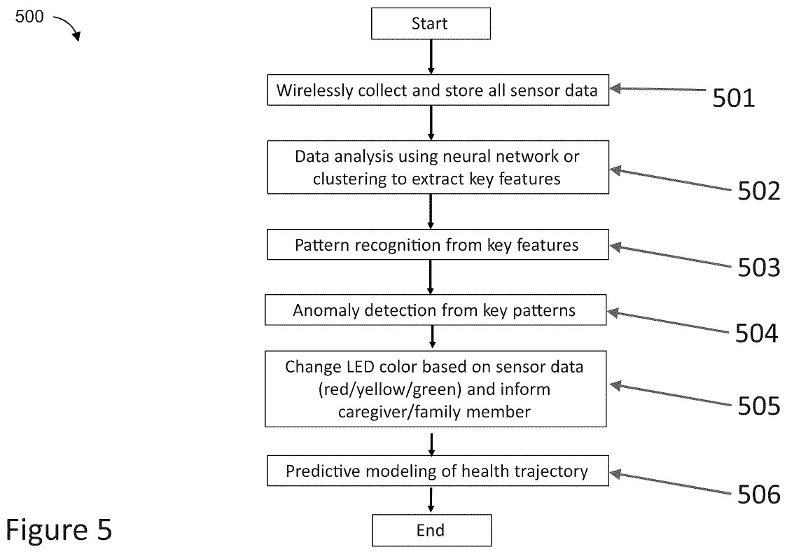

FIG. 5 illustrates a flow diagram depicting utilization of a trained machine learning model to generate health-related assessments according to some embodiments. Workflow 500 can be programmed in software code and stored in computer readable medium to be read and executed a machine learning model residing on a data server. Workflow 500 begins by wirelessly collecting and storing sensor data collected from one or more smart devices in the home environment at 501. Workflow 500 then continues with data analysis using neural networks or clustering algorithms to extract key features at step 502. The neural network machine learning algorithms may identify events/patterns based on those features at step 503 and then detect anomalies from the recognized patterns at 504. If there is unusual behavior, workflow 500 continues by informing the caregiver or family member at step 505. The alert can be in the form changing the LED status indicator light on one or more smart devices in the home or transmitting a notification to a device belonging to the caregiver or family member. These alerts and use cases and habits can be automatically created by the machine learning model or by the user. Based on long term trends of various behavior patterns, the machine learning model can be unsupervised or supervised learning. In an unsupervised model, all the data is automatically fed into the computer and ‘normal’ baseline data is created after a few months of monitoring. In a supervised learning model, certain thresholds are already pre-programmed. For example, if temperature and humidity or CO2 levels are out of normal range an alert is sent.

In another embodiment, the smart device can identify early onset of dementia based on activity changes that followed poor sleep patterns. A deep neural network (DNN) can learn and determine the most relevant features from the raw sensor data that are indicative of Alzheimer's and Dementia-related behaviors. For example, it can learn patterns in movement that suggest forgetfulness or detect anomalies in daily routines (i.e. walking to the kitchen repeatedly because of forgetting items). Over time, the DNN can recognize patterns in the sensor data that correlate with certain behaviors associated with cognitive decline, such as changes in (deep) sleep quality, irregular showering habits, or instances where the stove is left on.

In one embodiment, the network can be trained to identify deviations from normal behavior patterns. If a person starts taking showers less frequently than usual or leaves the stove on repeatedly, the DNN can flag these as anomalies that may indicate worsening symptoms.

After notifying the caregiver or family member, workflow 500 continues by updating predictive modeling of health trajectory at 506. As the DNN is exposed to more data over time, it can start to make predictions about the monitored person's health trajectory. For instance, if certain behaviors are increasing in frequency or new patterns emerge, the DNN can predict a higher likelihood of an acute event or suggest the need for medical intervention.

With recurrent neural networks (a type of DNN suited for time-series data), the system can understand the sequence and timing of events, which is crucial for monitoring diseases like Alzheimer's where the progression pattern over time is informative.

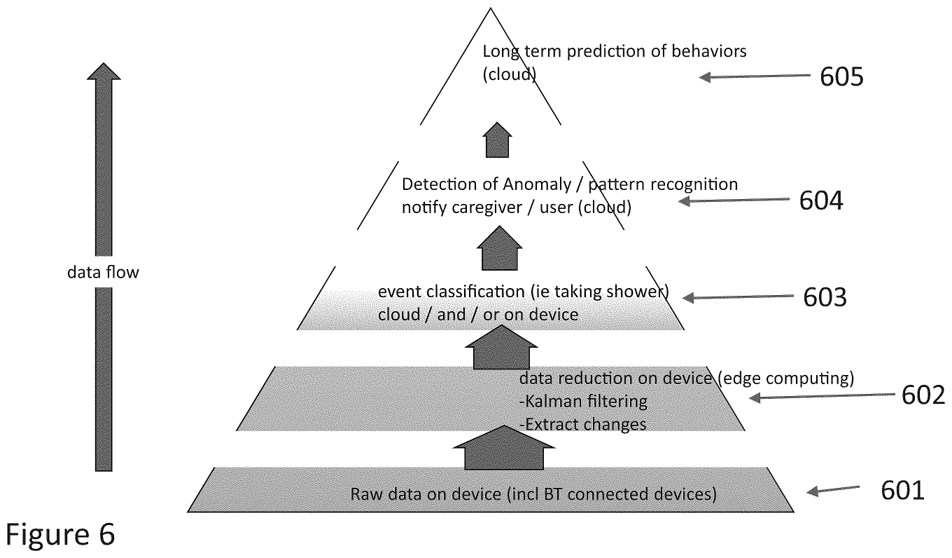

FIG. 6 illustrates how sensor data is processed according to some embodiments. On the bottom, level 601 consists of raw sensor data. The raw sensor data can be filtered into filtered data at level 602 where edge computing means Kalman filtering of the raw data can be applied to further filter the data. In one embodiment, edge computing may be performed by the smart device. At level 603, event classification can be applied to the filtered data and the event classification can occur on the smart device or in the cloud. Once the events are classified, the machine learning model searches for anomalies of patterns at 604. The machine learning model may be in the cloud. If any anomalies are found, the caregiver or other person monitoring can be notified. However, a logical hub can be assigned from any of the devices within the household to make a decision to notify the caregiver in a more timely fashion than the cloud for some short-term events. Long term data analytics and seasonal changes occur at level 605 and may require cloud computing.

FIG. 7 illustrates the classification of events that a deep neural network (DNN) can accomplish according to some embodiments. In some embodiments, the DNN 720 can receive one or more inputs from input data 710 to generate one or more output outputs from output data 720. Possible inputs for DNN 720 include sleep quality, moving patterns, VOCs, light sensors, social interaction, bathroom activity, data collected from other devices communicating wirelessly with the smart device, and air quality. These inputs may be generated by one or more smart devices located within the home by analyzing data collected from sensors and data collected from other devices (i.e. BT connected microphone or heart rate monitor). The DNN may receive the input variables and generate the output variables. The output variables can be a risk score for output data 730. For example, an output of the DNN 720 can be a risk score for cognitive decline, a risk score for physical impairments, a risk score for prostate issues, a risk score for heart issues, a risk score for asthma, a risk score for depression, and other risk scores. Although a correct health diagnostic should be done by a physician, the DNN can produce a risk score for various diseases based on the home environment and eating/sleep/bathroom patterns which may be useful for the caregiver and family members to keep track of the monitored subject in real time. For example, poor air quality is directly linked with high-risk pregnancies and asthma. If the Air quality index (AQI) is above 150, the smart device or the server may send an alert to the caregiver. Similarly, if the particle counter PM2.5 exceeds 10∫or above 35 pg/m3 (in a 24 hr window)—an alert may be sent to the caregiver and/or the user and the light on the device may change to red. Frequent bathroom activities are also strongly correlated with urinary tract infections and/or prostate bladder issues. Normal bathroom visits are 0 to 1 time per night. However, as people get older, the frequency of bathroom visits can increase slightly. If the smart device detects that the monitored person uses the restroom more than 3 times per night, the smart device may send an alert to the caregiver and user. However, if the monitored person drank coffee in the evening (which can be detected with VOC smell sensor) the threshold for notification increases—i.e. if ‘normal behavior’ of monitored person is 2 bathroom visits every night and the smart plug detects the monitored person drank coffee this evening and the bathroom visit frequency increases to 3× per night, no alert is sent to the caregiver because drinking coffee in the evening increases the number of bathroom visits. Yet another example for sleep anomaly tracking would be if the total sleep time is less than 6 hours and the total deep sleep time is less than Ihr. Again, typically every person should have about 25% of total sleep time to be in deep sleep. If it is less than that, an alert is sent out and if this happens repeatedly, the risk for Alzheimer's, heart disease, stroke and diabetes go up. After each week of poor deep sleep, the risk score will go up one point. Risk scores can range from 0 (low risk) to 10 (highest risk). Again, risk score depends also on the air quality, food type (VOC can smell fried food), alcohol consumption (VOC may be able to detect this), smoking habits and activity level and may also include data from Bluetooth connected devices, i.e. heart rate (i.e. Fitbit watch), and weight (BT scales). Publicly available information that shows correlation between environmental conditions and health issues can be used as training data for DNN 720. In some embodiments, the risk score can subsequently be shared with a health care professional, caregiver, or transmitted back to the smart device.

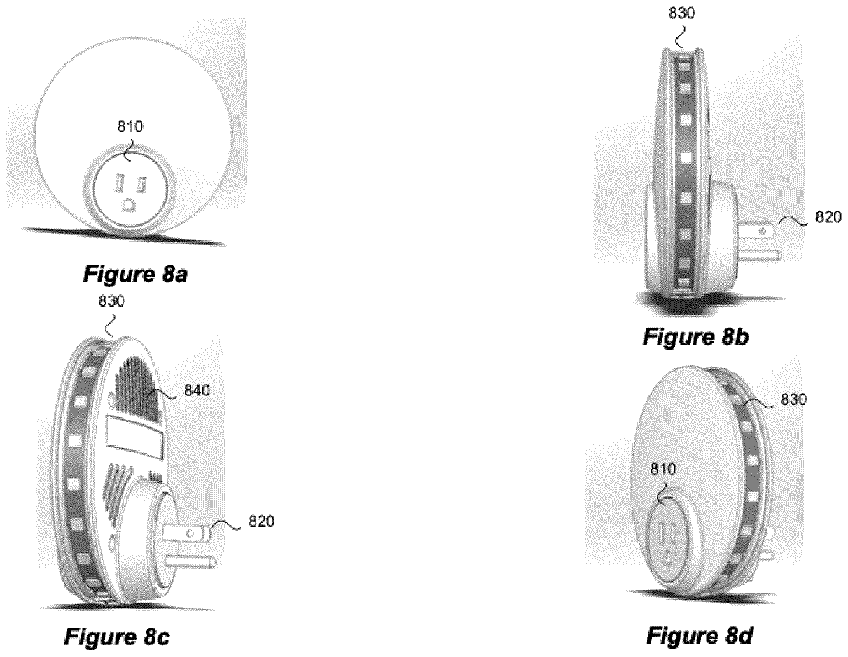

FIGS. 8a, 8b, 8c, and 8d illustrate different views of an exemplary smart device according to some embodiments. As shown in the front view of FIG. 8a, the smart device is circular in shape with a circular electric socket 810. A secondary electronic device may be plugged into electric socket 810. As shown in the side view of FIG. 8a, the smart device includes a set of electrical prongs 820 to be removably connected to a wall outlet or a socket of an extension cord. The smart device also includes a sensor array 830 around the perimeter of the smart device. Sensors of the sensor array may be dispositioned along the outer perimeter of the housing of the smart device. FIGS. 8c and 8d illustrate a peripheral view of the smart device. As shown in FIG. 8c, the smart device also includes vents 840 to cool the smart device.

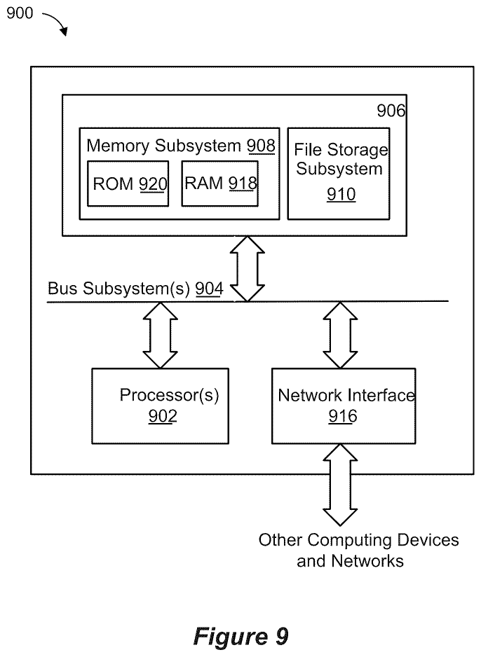

FIG. 9 depicts a simplified block diagram of an example computer system 900, which can be used to implement some of the techniques described in the foregoing disclosure. As shown in FIG. 9, system 900 includes one or more processors 902 that communicate with several devices via one or more bus subsystems 904. These devices may include a storage subsystem 906 (e.g., comprising a memory subsystem 908 and a file storage subsystem 910) and a network interface subsystem 916. Some systems may further include user interface input devices and/or user interface output devices (not shown).

Bus subsystem 904 can provide a mechanism for letting the various components and subsystems of system 900 communicate with each other as intended. Although bus subsystem 904 is shown schematically as a single bus, alternative embodiments of the bus subsystem can utilize multiple buses.

Network interface subsystem 916 can serve as an interface for communicating data between system 900 and other computer systems or networks. Embodiments of network interface subsystem 916 can include, e.g., Ethernet, a Wi-Fi and/or cellular adapter, a modem (telephone, satellite, cable, etc.), and/or the like.

Storage subsystem 906 includes a memory subsystem 908 and a file/disk storage subsystem 910. Subsystems 908 and 910 as well as other memories described herein are examples of non-transitory computer-readable storage media that can store executable program code and/or data that provide the functionality of embodiments of the present disclosure.

Memory subsystem 908 comprise one or more memories including a main random access memory (RAM) 918 for storage of instructions and data during program execution and a read-only memory (ROM) 920 in which fixed instructions are stored. File storage subsystem 910 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 900 is illustrative and many other configurations having more or fewer components than system 900 are possible.

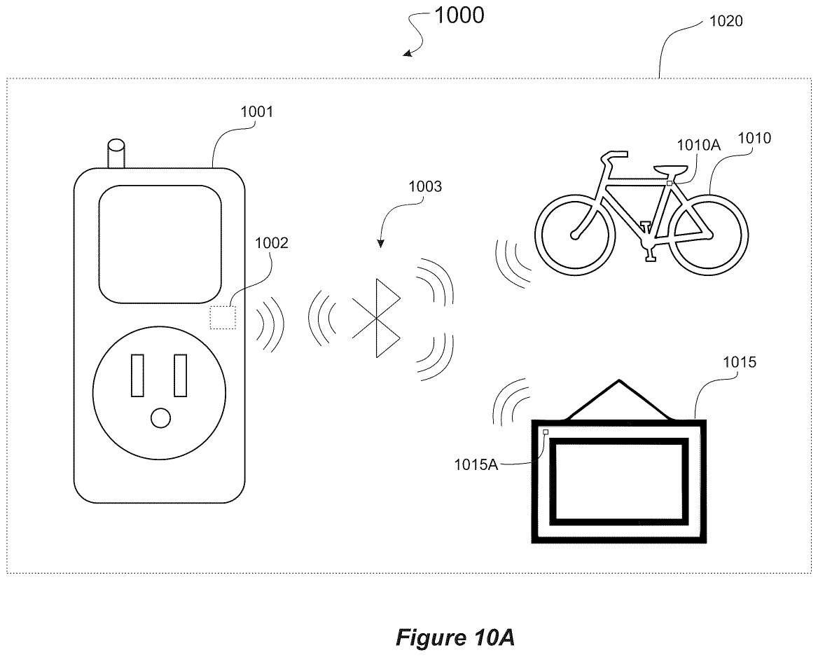

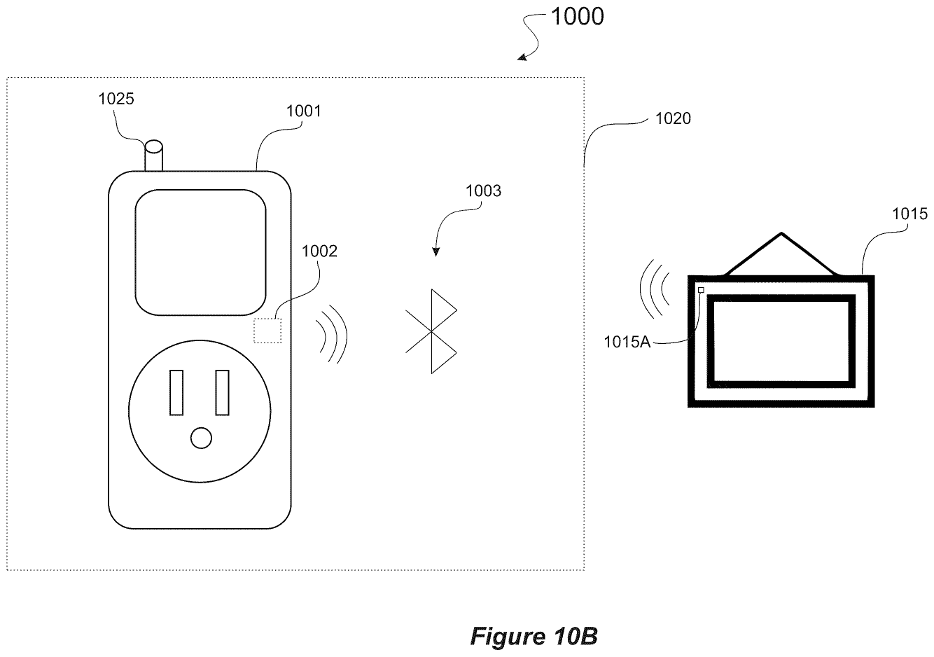

FIG. 10A illustrates an overview of an asset tracking module 1000 in which one or more BLE beacon tags attached to household items are detected by the smart device according to some embodiments. Referring to FIG. 10A, the smart device 1001 includes a wireless receiver 1002 configured to monitor beacon transmissions and determine the general location or presence of tagged items within a coverage area. The illustration shows multiple household objects (1010, 1015) equipped with BLE tags (1015A, 1015A respectively), each periodically transmitting identification signals 1003 that are received by the smart device to establish baseline positional information for later comparison and calculation. The household objects may include any items that a user wishes to track, including but not limited to appliances, electronics, vehicles, artwork, or other valuable assets. In the illustrated example, a bicycle 1010 and painting 1015 are shown for exemplary purposes, within a monitored area 1020, i.e. home environment.

In some embodiments, the asset tracking module additionally monitors for the presence of authorized user devices via Bluetooth, WiFi, or other wireless communication protocols. When an authorized user is detected within range, movement of tagged items may be treated as expected or permissible, whereas movement occurring in the absence of an authorized user may be classified as unauthorized and may trigger elevated alert responses.

FIG. 10B illustrates an example of the asset tracking module in use when a beacon tag is moved, lost, or stolen according to some embodiments. Referring now to FIG. 10B, in this example, the position or angle associated with a tagged item (e.g., painting 1015) changes relative to the smart device 1001, or the signal 1003 becomes undetectable when the item is removed from the monitored area 1020. The asset tracking module 1000 compares the newly received beacon information to the previously established baseline to determine whether unexpected displacement has occurred. When sufficient deviation is detected, the module may trigger an alert or an associated response. In one embodiment, the alert may be provided via an LED status indicator light 1025. In one embodiment, deviation detection is based on signal strength and the calculated position of each beacon tag relative to baseline location data for that tag. In some embodiments, the user may customize a threshold distance or signal change value to adjust the sensitivity of when an alert is provided via the LED status indicator light. In some embodiments, alert severity may be graduated based on factors including an assigned value tier of the tracked asset, the magnitude of displacement from the baseline position, and a time of occurrence associated with the detected movement. In some embodiments, the alert is transmitted to a caregiver device such as a smartphone or tablet, and the monitoring device activates a distinctive LED pattern, color, or blink rate to visually indicate the alert condition.

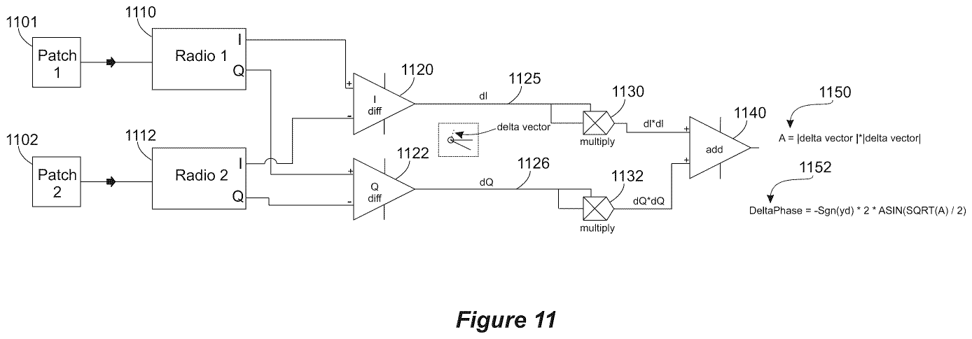

FIG. 11 illustrates an exemplary circuit diagram for the asset tracking module according to some embodiments. Referring now to FIG. 11, patch antennas 1101 and 1102 receive BLE signals from a beacon tag, as discussed above. Next, the received signals are provided to corresponding radio front ends 1110 and 1112, each configured to generate in-phase (I) and quadrature (Q) components of the incoming signal. Next, the I and Q outputs of radios 1110 and 1112 are provided to differential processing stages 1120 and 1122, which compute the differences between the respective I components and the respective Q components received at the two antennas. The resulting differential signals, identified as dI 1125 and dQ 1126, represent the phase and amplitude relationship of the beacon signal as detected across the spatial separation of antennas 1101 and 1102. Next, each differential component is then squared using multiplication stages 1130 and 1132, which generate dI×dI and dQ×dQ values. These squared differential terms are provided to a summation block 1140, which combines the values to produce a magnitude output 1150 representing the length of the differential vector between the two received signals. In some embodiments, this magnitude corresponds to the relative angle at which the BLE beacon signal arrives at the antenna pair. In one embodiment, the magnitude output 1150 represents a vector metric derived from the differential components dI and dQ, which in one implementation may be calculated as A=|delta vector|*|delta vector|. In some embodiments, other equivalent analog or digital formulations may be used. In some embodiments, this analog computation may further be used to derive a phase-based angular estimate 1152, enabling real-time directional determination without requiring digital signal processing. In some embodiments, a phase-difference value (DeltaPhase) may be derived from the differential vector magnitude, where the angular estimate may be computed according to the relationship: DeltaPhase=−Sgn(yd)×2×ASIN(SQRT(A)/2).

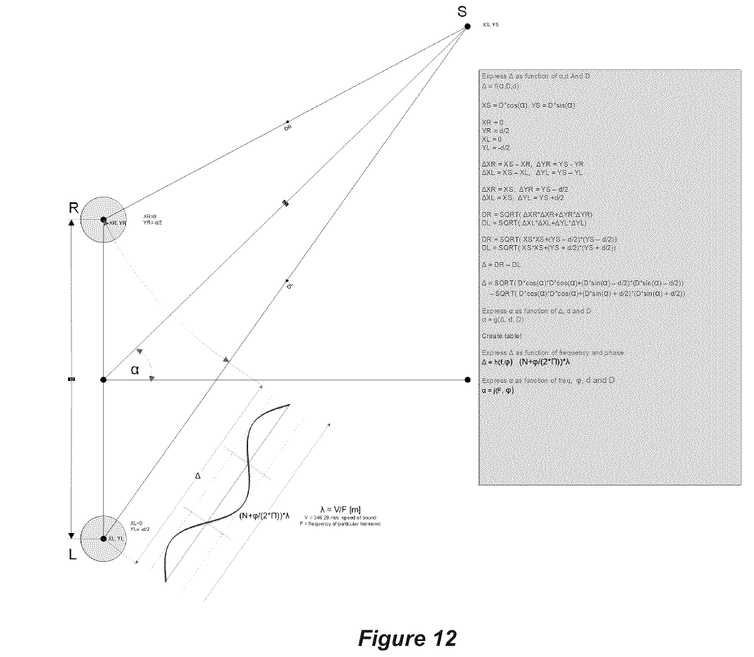

FIG. 12 illustrates an angle-of-arrival computation derived from the asset tracking module according to some embodiments. Based on the differential in-phase and quadrature components produced by the circuit of FIG. 11, the system computes a phase-difference value that directly represents an angle α between the line-of-sight vector to the BLE beacon and the axis defined by the two antennas of the receiver. In some embodiments, the circuit operates entirely in the analog domain to derive this angular estimate from the differential vector magnitude and sign information, without requiring digital signal processing or high-rate sampling. The resulting angle α may be used as a directional indicator for the beacon tag, enabling the monitoring device to determine whether a tracked asset has moved relative to the receiver and to estimate the direction of such movement within the home environment. Advantageously, the angle-of-arrival processing enables sub-meter location resolution of BLE beacon tags relative to the monitoring device, thereby supporting real-time location detection of asset movement within a monitored environment.

In some embodiments, the system may include two or more smart devices operating cooperatively within a home environment. Each device may independently compute an angular direction for a received 2.4 GHz signal, and the combined angular estimates may be used to triangulate or otherwise pinpoint the physical location of the emitting device. This enables location determination for a wide range of 2.4 GHz transmitters, including WiFi devices, Bluetooth devices, and BLE beacons, and may improve position accuracy for asset tracking, presence detection, or movement monitoring. In some embodiments, the system stores historical angular measurements, timestamps, and device detections to provide trajectory history, last known location information, and access or movement logs for asset recovery purposes.

Unlike conventional BLE direction-finding systems that rely on digital signal processing of sampled antenna-switching sequences, the disclosed circuit directly computes an angular estimate α from the differential in-phase and quadrature components of two simultaneous receive paths. By performing the vector operations and trigonometric conversion in analog hardware, the receiver obtains a real-time estimate of the beacon direction relative to the antenna pair with reduced processing overhead and power consumption, and without requiring a high-performance microcontroller or external DSP (Digital Signal Processing).

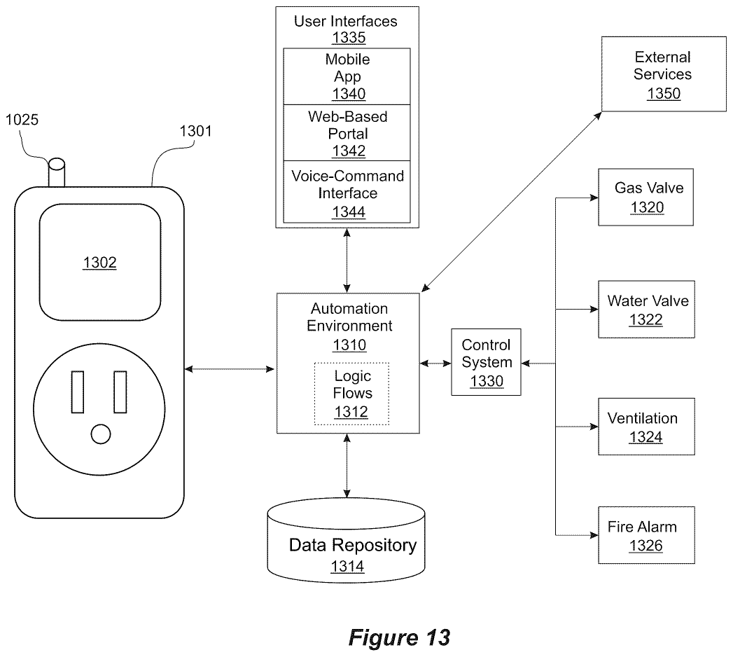

FIG. 13 illustrates an example smart home control and automation system 1300 implemented using a smart device 1301 integrated into a Node-RED, IFTTT, or similar automation ecosystem according to some embodiments. Referring now to FIG. 13, the smart device 1301 includes a sensor array 1302 configured to monitor environmental conditions as previously discussed and described above, including but not limited to gas concentration, volatile organic compounds (VOC), water presence, humidity, temperature, carbon dioxide (CO₂), and smoke signatures within a home environment. In some embodiments, sensor data generated by the sensor array 1302 is processed locally by a processor (902; FIG. 9) and transmitted via a network interface (916; FIG. 9) to a Node-RED automation environment 1310. The Node-RED environment executes one or more conditional logic rules defined within automation logic flows 1312, which evaluate sensor readings against configurable threshold values. When one or more thresholds are exceeded, the automation flows generate corresponding control signals.

In some embodiments, the conditional logic rules include shutting off a gas valve 1320 when gas concentration exceeds a predefined threshold, shutting off a water main via a water shutoff valve 1322 when water presence is detected, activating a ventilation system 1324 when CO₂ levels exceed a threshold, and triggering a fire alarm 1326 when a smoke signature is detected. In some embodiments, control signals are transmitted to smart home actuators using wireless communication protocols including WiFi, Bluetooth, Zigbee, Z-Wave, or other supported interfaces via a device control interface system 1330.

In some embodiments, the conditional logic rules and automation flows are user-configurable through a user interface 1335, including but not limited to a mobile application 1340, a web-based portal 1342, or a voice command interface 1344, allowing users to customize thresholds, actions, and automation behavior without modifying device firmware.

In some embodiments, the Node-RED automation environment 1310 implements visual programming constructs including sensor input nodes, function nodes that perform conditional logic, and actuator output nodes that issue control commands. Automation flows may further include multi-step sequences such as chained actions with time delays, parallel execution of multiple responses, and feedback loops that verify actuator effectiveness using subsequent sensor measurements.

In some embodiments, the automation flows integrate with external services 1350 including weather forecast services, utility pricing APIs, calendar services, or other data sources to optimize automation timing, safety responses, or energy efficiency.

In some embodiments, automation flows are stored locally within the smart device 1301 or within the Node-RED automation environment 1310, with cloud-based backup or data repository 1314 provided for redundancy, remote management, or restoration following device failure. In some embodiments, the external services 1350 may also be connected to the cloud-based backup or data repository.

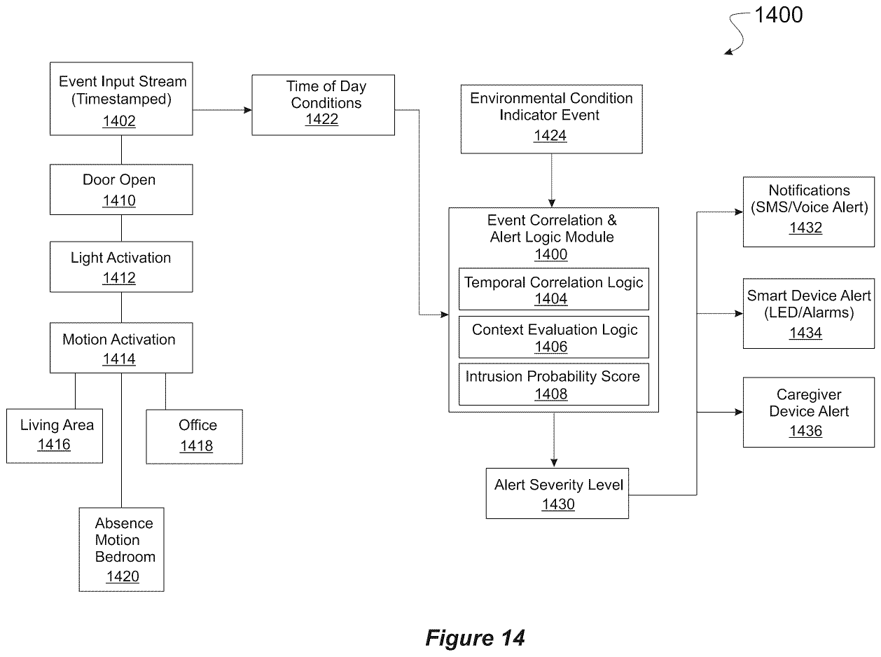

FIG. 14 illustrates an example multitiered event correlation and alert logic module 1400 according to some embodiments. Referring now to FIG. 14, the module receives an event input stream 1402 comprising signals generated by multiple sensors and system components within a monitored environment. The event input stream may include one or more of a door open event 1410, a light activation event 1412, motion activation and motion detection events 1414, 1416, and 1418 from different monitored areas, an absence-of-motion event 1420, time of day conditions 1422, and additional environmental indicators 1424 such as odor signatures, volatile organic compounds, smoke, alcohol, or other sensed conditions.

In some embodiments, each detected event is timestamped and associated with a location or zone within the monitored environment, and the event correlation logic computes an intrusion probability score based on the number, type, timing, and context of the detected events. In some embodiments, the event correlation module 1400 includes temporal correlation logic 1404 configured to evaluate whether one or more events occur within a configurable time window. The time window may be user-defined and may range from seconds to minutes, and the events may occur in any order. In some embodiments, an alert may be triggered by a single event type, while in other embodiments an alert may be triggered only when a combination of multiple events is detected within the time window.

In some embodiments, the event correlation module 1400 further includes context evaluation logic 1406 configured to assess environmental and situational context, including time of day, occupancy state, learned baseline behavior associated with the monitored environment, and user-defined modes such as home, away, or sleep. In some embodiments, suspicious activity is distinguished from normal behavior by comparing detected event patterns against the learned baseline behavior and by considering the current home mode.

In some embodiments, upon identifying an alert condition, the system determines an alert severity level 1430 based on the calculated intrusion probability score 1408, the number and type of correlated events, the duration or frequency of activity, the room or zone involved, and user-configured thresholds. Graduated alert responses and notifications 1432 may include logging detected events without notification for low intrusion probability, transmitting push notifications or application alerts for medium probability, and transmitting SMS messages and voice alerts and activating audible alarms for high intrusion probability.

In some embodiments, alert messages are routed through a remote cloud service and delivered to one or more user devices. In some embodiments, the system activates a local indicator output 1434, such as alarms or a multi-color LED or patterned illumination, where color, blink rate, or repetition frequency conveys the nature or severity of the detected event. In some embodiments, corresponding alert indications are also displayed on caregiver device 1436, including a remote monitoring device configured to mirror alert states associated with the monitored environment, including severity level, zone identification, and timestamp information.

In some embodiments, an alert condition may be rapidly disarmed or suppressed through authenticated user interaction, including mobile application authentication, voice passphrase recognition, proximity detection of authorized devices, or security code entry. In some embodiments, the system adapts over time by learning from false alarms, including adjusting threshold parameters based on user feedback and creating exception rules to reduce future false positives.

In one exemplary operating scenario, the event correlation and alert logic module 1400 is configured and set for “away mode” during nighttime hours. Within a configurable time window, such as approximately one to two minutes, the module may detect a sequence or combination of intrusion indicator events including a door open event 1410, a light activation event 1412, motion detection events 1414 and 1416 in multiple monitored rooms, a time-of-day condition 1422 indicating that the time is between approximately 2:00 a.m. and 6:00 a.m., and an absence of motion event 1420 indicating no detected motion in a bedroom area. When these events occur within the configured time window, the event correlation logic 1404 and context evaluation logic 1406 collectively increase the calculated intrusion probability score 1408, resulting in a high alert severity level 1430. In response to the elevated alert severity level, the system may transmit an SMS message and initiate a voice alert to a user device via the notification output 1432, while simultaneously activating a local indicator output 1434 on the smart device. In some embodiments, corresponding alert indications are also replicated on a caregiver monitoring device 1436, allowing a remote caregiver or authorized third party to receive the alert and view associated information such as severity level, affected zone, and event timing. In some embodiments, the same alert logic may be triggered by a single intrusion indicator event or by different combinations of events, including environmental indicator events 1424 such as detected odor signatures, alcohol presence, smoke, or fire, or by patterns of erratic movement across multiple rooms.

In some embodiments, the system allows the user to configure alert triggers, thresholds, monitored zones, and armed states based on personal preferences or usage scenarios. For example, a user may configure alerts to be generated only when activity occurs within a designated room containing valuable assets, thereby reducing false alarms caused by authorized personnel such as cleaning services, pet sitters, or caregivers. The configurable nature of the event correlation logic enables flexibility in adapting the system to different household routines and security requirements. In some embodiments, an alert condition may be rapidly disarmed or suppressed through authenticated user interaction, including mobile application authentication, voice passphrase recognition, proximity detection of authorized devices, or security code entry. In some embodiments, the system adapts over time by learning from false alarms, including adjusting threshold parameters based on user feedback and creating exception rules to reduce future false positives.

In some embodiments, data generated by the smart monitoring device and associated sensor systems may be recorded, secured, or managed using distributed ledger or blockchain-based technologies. In such embodiments, sensor data, event logs, or derived metrics produced by the smart device may be cryptographically secured to provide tamper-resistant data integrity and verifiable provenance. The data may further be tokenized, enabling representation of monitored data as digital assets associated with ownership, access rights, or economic value attributable to the monitored individual. This approach may allow users, caregivers, or beneficiaries to retain control over personal monitoring data and optionally participate in data-driven incentive or credit systems. In some embodiments, tokenization techniques similar to those used for environmental or carbon-credit accounting may be applied to monitoring data. In some embodiments, the system may balance enhanced encryption, security, and ledger verification against power consumption or environmental impact by selectively securing, batching, or offloading data processing operations.

### Further Examples

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a home monitoring device, comprising: a housing having electrical prongs adapted to be plugged into a first electrical outlet in the home; a sensor array housed within the housing, the sensor array including a plurality of sensors configured to generate sensor data related to the ambient environment surrounding the home monitoring device, wherein the plurality of sensors do not include audio or video sensors; a wireless interface housed within the housing configured to communicate with a data server; a LED status indicator light attached to an edge of the housing configured to provide notifications; and a processor housed within the housing and in communication with the sensor array, the wires interface, and the LED status indicator light, the processor configured to execute software containing instructions to: receive the sensor data from the sensor array; transmit the sensor data to the data server via the wireless interface; receive an outcome from the data server via the wireless interface, the outcome based on analysis of the sensor data by the data server; transmitting signals to the LED status indicator light, the signals configured to light up the LED status indicator light a color that corresponds with the outcome.

In one embodiment, the home monitoring device further comprises a second electrical outlet configured to receive an electronic device, wherein the home monitoring device provides power to the electronic device through the second electrical outlet.

In one embodiment, the home monitoring device monitors the power consumption of the electronic device.

In one embodiment, the home monitoring device is powered solely by power received from the first electrical outlet.

In one embodiment, the plurality of sensors include a temperature sensor, a smell sensor (volatile organic compounds—VOC, Volatile sulfur compounds—VSC), a presence radar sensor, a CO2 gas sensor, and a light sensor.

In one embodiment, the outcome received from the data server includes a risk score indicating the likelihood of a disease.

In some embodiments the present disclosure includes a method, comprising: receiving, from at least one sensor in a sensor array, sensor data collected from monitoring an ambient environment of a home monitoring device; storing the sensor data in a local memory, the local memory storing other sensor data; analyzing the sensor data and the other sensor data in local memory; determining that an unusual behavior has occurred in the ambient environment in response to the analysis; and setting the color of an LED status light indicator based on the determined unusual behavior.

In one embodiment, the method further comprises generating a smell fingerprint from the sensor data.

In one embodiment, the smell fingerprint includes a reference room smell and a monitored subject smell.

In one embodiment, the method further comprises transmitting the sensor data and the unusual behavior to a data server.

In one embodiment, the method further comprises receiving a risk score from the data server, the risk score indicating the likelihood of a disease.

In one embodiment, the method further comprises transmitting the unusual behavior to a device operated by a caregiver of a monitored subject within the ambient environment.

In one embodiment, the method further comprises wirelessly receiving data from another health tracker device, wherein the received data is included in the analysis.

In one embodiment, synergistic analysis is performed on the received data and the sensor data to generate an inference, wherein a notification is transmitted to a caregiver based on the inference.

In some embodiments, a non-transitory computer-readable medium stores a program executable by one or more processors, the program comprising sets of instructions for receiving, from at least one sensor in a sensor array, sensor data collected from monitoring an ambient environment of a home monitoring device; storing the sensor data in a local memory, the local memory storing other sensor data; analyzing the sensor data and the other sensor data in local memory; determining that an unusual behavior has occurred in the ambient environment in response to the analysis; and setting the color of an LED status light indicator based on the determined unusual behavior.

In one embodiment, the non-transitory computer-readable medium further comprises generating a smell fingerprint from the sensor data.

In one embodiment, the smell fingerprint includes a reference room smell and a monitored subject smell.

In one embodiment, the non-transitory computer-readable medium further comprises transmitting the sensor data and the unusual behavior to a data server.

In one embodiment, the non-transitory computer-readable medium further comprises receiving a risk score from the data server, the risk score indicating the likelihood of a disease.

In one embodiment, the non-transitory computer-readable medium further comprises wirelessly receiving data from another health tracker device, wherein the received data is included in the analysis.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, references to “first,” “second,” “third,” and etc. members throughout the disclosure (and in particular, claims) are not used to show a serial or numerical limitation but instead are used to distinguish or identify the various members of the group.

What is claimed is:

1. A method for asset tracking in a home environment, comprising steps:
attaching BLE beacon tags to valuable assets;
detecting BLE signals from the beacon tags using a home monitoring device with AoA capability;
establishing baseline location data for each beacon tag;
monitoring signal strength and calculated position of each beacon tag;
generating a theft alert when a beacon tag moves beyond a threshold distance or the BLE signal is lost for a predetermined time.

2. The method of claim 1, wherein the AoA capability determines beacon location by measuring phase differences between signals received at multiple antennas and calculating angular direction.

3. The method of claim 1, further comprising a step of distinguishing authorized movement from unauthorized movement by detecting presence of authorized user devices via Bluetooth or WiFi.

4. The method of claim 1, further comprising a step of generating graduated alert severity levels based on asset value tier, distance moved, and time of occurrence.

5. The method of claim 1, further comprising a step of providing asset recovery information including last known location, trajectory history, and historical access logs.

6. The method of claim 1, further comprising a step of transmitting the theft alert to a caregiver device and activating a distinctive LED pattern on the monitoring device.

7. A smart home control method, comprising steps:
monitoring environmental conditions including gas concentration, VOC, water presence, humidity, and temperature using a sensor array;
executing conditional logic rules based on sensor thresholds using IFTTT or Node-RED protocols;
transmitting control signals to smart home actuators via wireless protocols when thresholds are exceeded;
wherein the conditional logic rules include: shutting off gas valve when gas detected, shutting off water main when leak detected, activating ventilation when CO2 exceeds threshold, and triggering fire alarm when smoke signature detected.

8. The method of claim 7, wherein the conditional logic rules are user-configurable through a mobile application, web portal, or voice command interface.

9. The method of claim 7, further comprising a step of implementing Node-RED visual programming with sensor input nodes, function nodes for conditional logic, and actuator output nodes.

10. The method of claim 9, further comprising a step of executing multi-step automation sequences including chained actions with time delays, parallel execution of multiple responses, and feedback loops incorporating sensor verification.

11. The method of claim 7, further comprising a step of integrating with external services including weather forecasts, utility pricing APIs, and calendar services to optimize automation timing.

12. The method of claim 7, further comprising a step of storing automation flows locally with cloud backup for redundancy.

13. An intelligent burglar detection method, comprising steps:
monitoring for intrusion indicator events including at least one of:
door openings, window openings, light activations, and motion in unoccupied zones using distributed home monitoring devices;
timestamping and geo-tagging each detected event;
analyzing an event sequences of the the detected event occurring within a configurable time window;
calculating an intrusion probability score based on satisfaction of multiple contextual conditions of the detected event; and
implementing a graduated alert response based on the intrusion probability score.

14. The method of claim 13, wherein the multiple contextual conditions include: entry detection, interior illumination activation, movement in living room, movement in office, event occurrence during 2 am-6 am, and absence of motion in bedroom.

15. The method of claim 13, wherein the graduated alert response includes: logging event for low probability, sending push notification for medium probability, and sending SMS with voice call and activating loud alarm for high probability.

16. The method of claim 13, further comprising a step of distinguishing suspicious patterns from normal activity by comparing against learned baseline behavior and considering current home mode.

17. The method of claim 13, further comprising a step of providing rapid disarming of the graduated alert response through a mobile app authentication, a voice passphrase, a proximity detection of authorized devices, or a security code entry.

18. The method of claim 13, further comprising a step of learning from false alarms by adjusting threshold parameters based on user feedback and creating exception rules.

19. The method of claim 13, further comprising a step of replicating alert status on a designated caregiver's remote monitoring device including LED pattern, zone identification, timestamp, and severity level.
